(19) United States
(12) Patent Application Publication
(10) Pub. No.: US 2004/0224821 A1
(43) Pub. Date: Nov. 11, 2004

(54) Drive train in particular for a motor vehicle

(75) Inventors: Markus Hausner, Karlsruhe (DE); Roland Seebacher, Neuried-Ichenheim (DE); Matthias Zink, Ottenhoefen (DE); Alexander Wuhrer, Nussloch (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LuK Lamellen und Kupplungsbau Beteiligungs KG, Buehl (DE)

(21) Appl. No.: 10/831,024

(22) Filed: Apr. 23, 2004

(30) Foreign Application Priority Data
May 2, 2003 (DE) DE 103 19 619.6

(51) Int. Cl. B60K 41/20

(52) U.S. Cl. 477/182

(57) ABSTRACT

In a drive train, in particular for a motor vehicle, including a drive engine, a transmission, a clutch connecting the two, and a drive shaft, clutch judder noticeable by the driver of a motor vehicle may be reduced by placing a braking device in the drive train, the braking device being coupled with a control unit which is connected to sensors for detecting clutch judder.

This claims the benefit of German Patent Application No. 103 19 619.6, filed May 2, 2003 and hereby incorporated by reference herein.

### BACKGROUND

The present invention relates to a drive train, in particular for a motor vehicle, including a drive engine, a transmission, a clutch connecting the two, and a drive shaft.

Such a drive train is known, for example, from German Patent Application No. DE 101 38 722. As the vehicle moves away from a standstill, alternating torques are introduced into the drive train by the slipping clutch. Many vehicles have a sensitive response to that phenomenon, taking the form of vibrations which the driver can feel, known as clutch judder. A reduction in the clutch judder is theoretically possible by reducing the excitation, for example, by making the clutch linings and clutch disks as flat and even as possible. However, there are manufacturing limits to this approach, which means that there will always be some residual excitation.

### BRIEF SUMMARY OF THE INVENTION

An object of the present invention is to reduce the clutch judder noticeable by the driver of the motor vehicle.

The present invention provides a drive train in particular for a motor vehicle, including a drive engine, a transmission, a clutch connecting the two, and a drive shaft, in which a braking device is situated in the drive train and is coupled with a control unit which is connected to sensors for detecting clutch judder. The control unit may be any type of hydraulic, pneumatic, mechanical, or electronic device, which is able to analyze signals supplied by sensors and convert them into control pulses for the braking device. In a hydraulic brake system, for example, the control unit thus also includes a master cylinder. The sensors for detecting clutch judder may be rotational speed sensors within the drive train which make it possible to detect the moving away of the vehicle as such, for example, sensors for determining the engine speed and sensors for determining the wheel speed, but they may also be vibration sensors or acceleration sensors or a combination thereof. Fundamentally any kind of sensor may be used here that makes it possible to draw conclusions as to the operational state of the vehicle and in particular as to a moving-off operation which may possibly entail the occurrence of clutch judder. In using the drive train proposed here for reducing clutch judder, it is thus also possible to widen the manufacturing tolerances for the clutch, possibly resulting in reduction in its manufacturing costs. In addition, the use of the drive train according to the present invention may cause a reduction in the number of complaints relating to clutch judder.

In a refinement of the drive train according to the present invention, the braking device is a shaft brake assigned to the primary or secondary side of the transmission. The primary side is the side of the transmission connected to the engine; the secondary side is the side of the transmission connected to the differential or to the wheel or wheels. The shaft brake may be of any desired design, including disk brakes, drum brakes, hydrodynamic brakes, eddy current brakes, or the like. In a refinement of the drive train according to the present invention, the braking device is a service brake or parking brake assigned to one wheel. The service brake is the brake generally operable by the driver using a foot pedal, and utilized during driving, while the parking brake is generally a brake which may be applied for a longer period by an independent operating device, such as a hand brake lever, utilized while the vehicle is parked. The service brake and the parking brake are often combined and act on the same braking devices. In accordance with the present invention, the service or parking brake is additionally used to minimize clutch judder by dynamic braking while the vehicle is moving off.

In a refinement of the drive train according to the present invention, the braking device includes several service or parking brakes, each of them being assigned to one wheel. In the case of a four-wheel vehicle, for example, the two service or parking brakes assigned to the two driven wheels may be used. In the case of a four-wheel all-wheel-drive vehicle, all four service or parking brakes on the four driven wheels may be used. In the case of two driven wheels, it is additionally or alternatively possible to use the brakes of the non-driven wheels.

The drive train according to the present invention is particularly advantageously used in a shiftable transmission. With such a transmission the shifting operation may be either manual or automatic. It is, however, also possible to reduce or compensate for effects comparable to clutch judder occurring during shifting of an automatic transmission, by using the drive train according to the present invention.

The present invention also provides a method for reducing clutch judder in a drive train, in particular of a motor vehicle, the drive train including a drive engine, a transmission, a clutch connecting the two, a drive shaft, and at least one braking device, the braking device being activated when clutch judder occurs. The braking device is preferably activated by a control unit, which may be, for example, an electronic controller in the form of a stored-program digital computer. The controller may be integrated into already existing controllers of an anti-lock brake system.

The braking device is preferably activated dynamically. This means that the control unit may activate the braking device dynamically and variably between a zero position in which there is no braking effect and a predefined maximum value, which should be selected significantly below the level at which the wheels will lock. Dynamic activation of the braking device causes the clutch judder occurring in the vehicle to be compensated for. The drive train, the motor vehicle in its entirety, the braking device, and the control unit thus form a closed-loop control circuit in which the brake line of the braking device is controlled and the controlled variable being the clutch judder intensity. In a further embodiment of the method according to the present invention, therefore, the dynamic activation of the braking device is controlled as to amplitude, frequency, and phase in such a way that the braking torque of the braking device counteracts the clutch judder.

The method for compensating for clutch judder in a drive train of a motor vehicle is carried out in a further embodiment of the present invention using the device discussed above.

The present invention also provides a method for compensating for clutch judder in a drive train including a drive engine, a transmission, a clutch connecting the two, and at least one driven wheel of a motor vehicle, the wheel being connected to the vehicle body via a connecting element, the gap between the natural frequencies of the engine-wheel and wheel-body oscillating systems to each other being increased while the vehicle is moving off. The connecting element, which connects the wheel to the vehicle body, is generally a spring or combination of a spring with a viscous damper. It may also be a hydraulic or pneumatic shock absorber which may be present in addition to a supplementary spring. In a further embodiment of the method according to the present invention, the natural frequency of the wheel-body oscillating system is increased. In order to change the natural frequency of the wheel-body oscillating system, the stiffness of the connecting element is changed while the clutch is being engaged. This may take place, for example, using a method in which parts of a coil or leaf spring are clamped in such a way that their spring constant is briefly significantly increased. Alternatively, the chassis bearing, for example, a pivot bearing of a leading link or transverse link, may be influenced. This may take place, for example, by providing additional dry or wet friction using clamping means such as clamping jaws, or the like. Alternatively, the use of rheological fluids within the bearing system is also conceivable. In addition, the stiffness of the connecting element may be increased while the clutch is being engaged.

The present invention also provides a motor vehicle including a drive train having a drive engine, a transmission, a clutch linking the two, and at least one driven wheel which is connected to a vehicle body via a connecting element, the gap between the natural frequencies of the engine-wheel and wheel-body oscillating systems to each other being changeable. Also provided is a motor vehicle which includes means to carry out the method described above for compensating for clutch judder in a drive train. In a refinement of the motor vehicle according to the present invention, the stiffness of the connecting element is changeable. Preferably the spring stiffness of the connecting element is changeable. As an alternative, for example, the damping of the connecting element may also be changeable. The stiffness of the connecting element is preferably controllable, i.e., the stiffness may be adjusted over a certain range. Controllability is to be taken as also meaning a change in stiffness over time. In a further embodiment, the motor vehicle includes a means for controlling the stiffness of the connecting element. The means for controlling the stiffness of the connecting element preferably includes an electronic control unit. The electronic control unit is preferably connected to sensors for measuring clutch judder. The connecting element may include a rheological fluid.

The present invention also relates to a hydraulic brake system in particular for motor vehicles, including a master cylinder, a slave cylinder, and a pressure medium line connecting the two. The master cylinder is generally linked to a brake pedal of a motor vehicle. The slave cylinder or slave cylinders are generally hydraulic brake cylinders in disk or drum brakes.

The present invention has the further object of providing a hydraulic brake system which offers enhanced functionality within a simple design. The present invention also provides a hydraulic brake system, in particular for motor vehicles, including a master cylinder, a slave cylinder, and a pressure medium line connecting the two, at least one hydraulic pump being situated in the pressure medium line. It is particularly advantageous if the pressure in the slave cylinder may be increased and/or decreased relative to the pressure in the master cylinder by using the pump. The hydraulic pump may be driven mechanically, pneumatically, hydraulically, or, preferably, electrically using an electric motor, or the like.

In a refinement of the present invention, the hydraulic brake system includes several slave cylinders and a hydraulic pump being assigned to each slave cylinder. In a standard four-wheel motor vehicle the service brake system includes four slave cylinders, i.e., four hydraulic pumps are provided, each assigned to one of the slave cylinders.

In a refinement of the hydraulic system, it also includes a control unit, at least one sensor for measuring state variables, and/or process variables of a motor vehicle being assigned to the control unit. State variables or process variables are to be understood here as physical variables which are suited to describe the operational state of the motor vehicle, such as, for example, acceleration, speed, engine speed, wheel speed, vibration of individual components, or the like. At least one sensor for measuring the speed of at least one of the wheels is preferably assigned to the control unit. Such a sensor is generally already present in standard present-day motor vehicles, as part of an anti-lock brake system.

In a refinement of the hydraulic brake system, the sensors cooperate with the control unit in such a way that control signals for influencing the pumps are obtained from sensor signals. The control signals influencing the pumps are preferably conditioned in such a way that locking of the wheels is prevented. This type of functionality is generally described as an anti-lock brake system.

The present invention also provides an anti-lock brake system, in particular for motor vehicles, in which a pump is assigned to each brake. In a refinement of the anti-lock brake system, the pressure of at least some of the brakes is changeable by the pump assigned to them, relative to the pressure of the respective master cylinder. A change in pressure shall be understood as an increase in pressure or a decrease in pressure. The pressure predetermined by the master cylinder, and therefore by the brake pedal, is thus dynamically modulated upwards by a pressure increase or pressure decrease generated by the respective pumps. The hydraulic system includes, therefore, a control unit which includes means having the functionality of an anti-lock brake system. In particular, the control unit may include stored-program electronic computers. The objects mentioned earlier are achieved through a sub-assembly characterized by a feature as described in the present documentation.

### BRIEF DESCRIPTION OF THE DRAWINGS

Exemplary embodiments of the present invention are described in greater detail below, on the basis of the appended drawings, in which:

FIG. 1 shows a schematic diagram of a drive train of a motor vehicle;

FIG. 2 shows a schematic diagram of a motor vehicle as an oscillating system; and

FIG. 3 shows a diagram of a hydraulic system of a motor vehicle on the basis of a service brake system.

### DETAILED DESCRIPTION

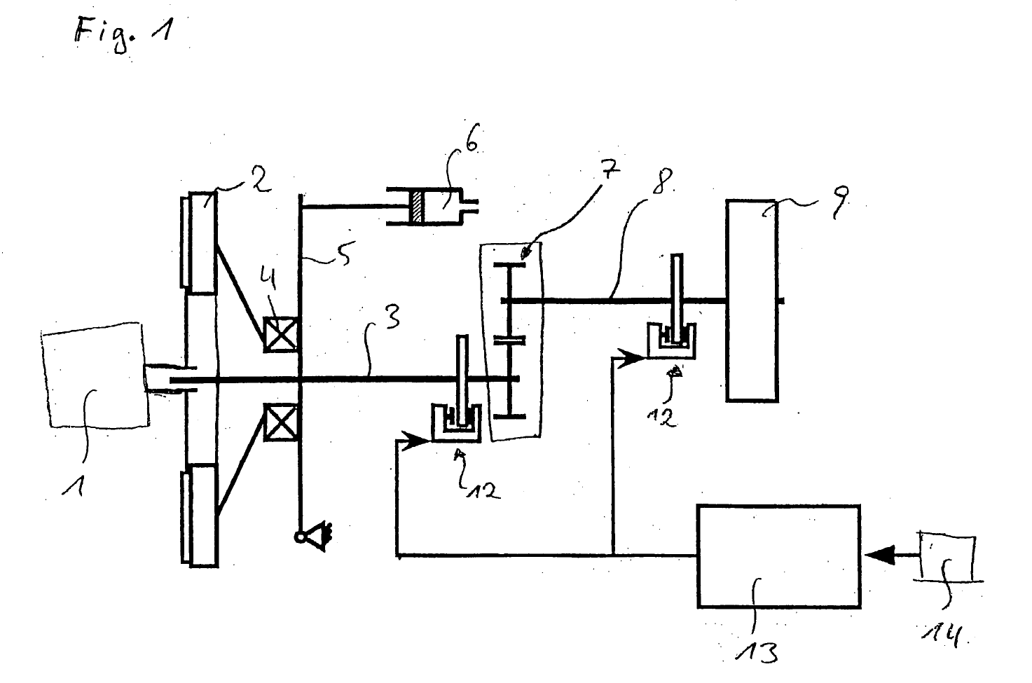

FIG. 1 shows a schematic diagram of a motor vehicle drive train. Drive engine 1 is connected via an operable clutch 2 to a clutch shaft 3. Clutch 2 is a dry clutch which is operable by a slave cylinder 6, using a release lever 5 via a release bearing 4. Slave cylinder 6, in turn, is part of a hydraulic system, not shown, which may be hydraulically pressurized by a master cylinder using a clutch pedal or an electric actuator, or the like. Activation using release lever 5 and slave cylinder 6 is to be understood here to be representative for all types of clutch release systems; for example, electrical or mechanical or hydraulic central clutch release systems, or the like, may also be used here. Similarly, clutch 2, rather than being a mechanical dry clutch, may also be a hydraulic wet clutch, or the like. Clutch shaft 3 is connected to a transmission 7 which is shown only in outline in FIG. 1. Transmission 7 may be any type of continuously adjustable, shiftable, or non-shiftable transmission, and, in the case of a shiftable transmission, it may have any desired number of gears. Similarly, transmission 7, clutch shaft 3, and clutch 2 may be one arm of a twin-clutch transmission. Transmission 7 will preferably be a conventional transmission, the type of shifting operation, such as dog-type, hydraulic, or the like, being of any desired form. Fundamentally, therefore, transmission 7 represents any type of known transmission. The output of transmission 7 is connected to an output shaft 8, which normally acts upon a wheel 9 via a differential, not shown here. In FIG. 1, a differential, such as is needed if a motor vehicle has two driven wheels, may be considered to be a part of transmission 7. Similarly, transmission 7 may also represent a more complex transmission in an all-wheel-drive vehicle having several differentials. A transmission that acts upon a single wheel 9, as shown in FIG. 1, could, for example, be implemented on a two-wheel vehicle.

Clutch shaft 3 is situated on the primary side of transmission 7, output shaft 8 is situated on the secondary side 11 of transmission 7. A braking device 12 is situated on clutch shaft 3 and thus on the primary side or on output shaft 8 and thus on the secondary side. Alternatively, braking devices 12 may be situated both on the primary side and on the secondary side. If braking device 12 is situated on the secondary side, braking device 12 may simultaneously be the service brake of the motor vehicle, known per se. This is normally composed of a disk brake having a disk mounted on the shaft and a brake caliper including brake pads mounted on the body. If braking device 12 is situated on primary side 10 of transmission 7, here too, a disk brake of the known type may be used, but other types of brakes such as hydraulic braking devices, eddy current brakes, or the like, may also be used. A control unit 13 controls braking device 12. Normally, braking device 12, in particular when it is situated on the secondary side, is activated hydraulically, and in this case control unit 13 generates or modulates the hydraulic pressure which is applied to braking device 12. An arrow in the representation in FIG. 1 indicates this. If braking device 12 is operated pneumatically, mechanically, or electrically, the control or modulation signals emitted by control unit 13 are also pneumatic, mechanical, or electrical. Control unit 13 thus generates on its output side, depending on the design of braking device 12, an electrical signal, a pneumatic or hydraulic pressure, or a mechanical force. Control unit 13 is connected to one or more sensors 14. The sensor or sensors is/are able to measure state variables and/or process variables of the drive train, which indicate present or future occurrences of clutch judder. Such state or process variables may be, for example, acceleration of the vehicle, engine and/or transmission speed, wheel speed, vibrations in certain parts, for example vibrations in the motor vehicle body, or the like. Sensors 14 are preferably able to measure variables which occur, for example, within the context of an anti-lock brake system or the engine management system of a motor vehicle.

In particular when braking device 12 is situated on the secondary side, the entire system for suppressing clutch judder may largely be integrated into already existing anti-lock brake systems. Unlike anti-lock brake systems of the known type, the entire system does not go into action only when the motor vehicle driver operates the service brake, but also when clutch 2 is engaged. When clutch 2 is engaged and clutch judder occurs simultaneously, the service brake of the motor vehicle is activated via installed control units, represented in FIG. 1 by control unit 13. Activation takes place dynamically, and variable braking torques generated by braking device 12, or in the case of several driven wheels by several braking devices 12, cause a torque, directed against the judder torques generating the clutch judder, to be created and superimposed on the drive train. Ideally, the judder torques and the superimposed counter torque generated by a braking device 12 or several braking devices 12 are exactly equal, so that the judder torque, and thus also the clutch judder, are completely compensated for.

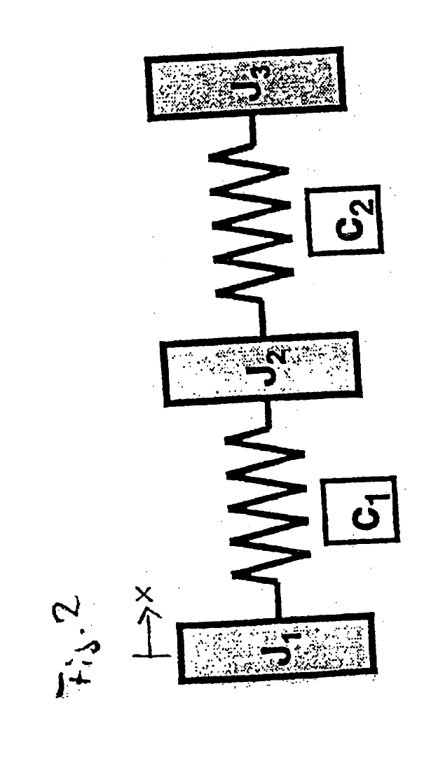

FIG. 2 shows a further exemplary embodiment of a method or of a motor vehicle or system for reducing clutch judder. FIG. 2 shows schematically the general physical background. J₁ in FIG. 2 represents the rotating mass J₁ of the clutch disk including the transmission, rotating mass J₂ represents the wheel mass, and J₃ represents the vehicle mass. Connection C₁ represents the drive train and connection C₂ represents the translational connection of the driven wheels to the body. The model shown in FIG. 2 uses generalized or abstracted variables instead of the actually occurring translational or rotational excursions, speeds, accelerations, forces, or masses. In relation to an excursion X, the oscillating system has the two natural frequencies F01 and F02, F01 being lower than F02. F01 is the natural frequency of the open drive train and thus the judder frequency. F02 is the translational natural frequency of the driven wheels. The amplification function in the case of forced oscillations shows a relation between the gap between the two natural frequencies and the judder amplitudes in the vehicle; the closer the two frequencies, the greater the amplitudes of the forced oscillations. In vehicles which demonstrate noticeable clutch judder problems at excitation values of the clutch which are within acceptable bounds, there is typically a significant amplification of the forced oscillations. The problem of clutch judder may thus be solved by a reduction in the amplification.

While the vehicle is moving away from a standstill, it is ensured that the two natural frequencies are as far apart as possible. To this end, either the generalized oscillation parameters of the drive train, as in the representation in FIG. 2, in other words J₁, J₂, or C₁, may be changed, or alternatively, the corresponding parameters of the wheel-body system, as shown in FIG. 2, in other words, J₃ and C₂ in particular, may be changed. A change in the vehicle mass is not practically possible. According to the present invention, therefore, the stiffness of the translational link of wheels C₂ is increased during moving off, in order to obtain the largest possible gap, i.e. the interval, between F01 and F02. This may be achieved using adjustable chassis bearings, e.g., using rheological fluids, or the like. The damping effect of currently generally used viscous dampers could alternatively be briefly and sharply increased via a shutoff valve, or the like. The wheel speed is used to detect the intention to drive away, in order to recognize wheel and engine speeds and degrees of clutching that are critical for clutch judder. When a shutdown criterion is reached, for example, a certain wheel speed or a drop below a specified clutch slip, the bearings are switched back to their original stiffness. A change in stiffness C₂, for example, may be achieved by clamping the pivot bearing of a leading link or transverse link, for example, via a clamping mechanism which increases the friction of the bearing due to direct action on an axle spring or a combination spring/damper.

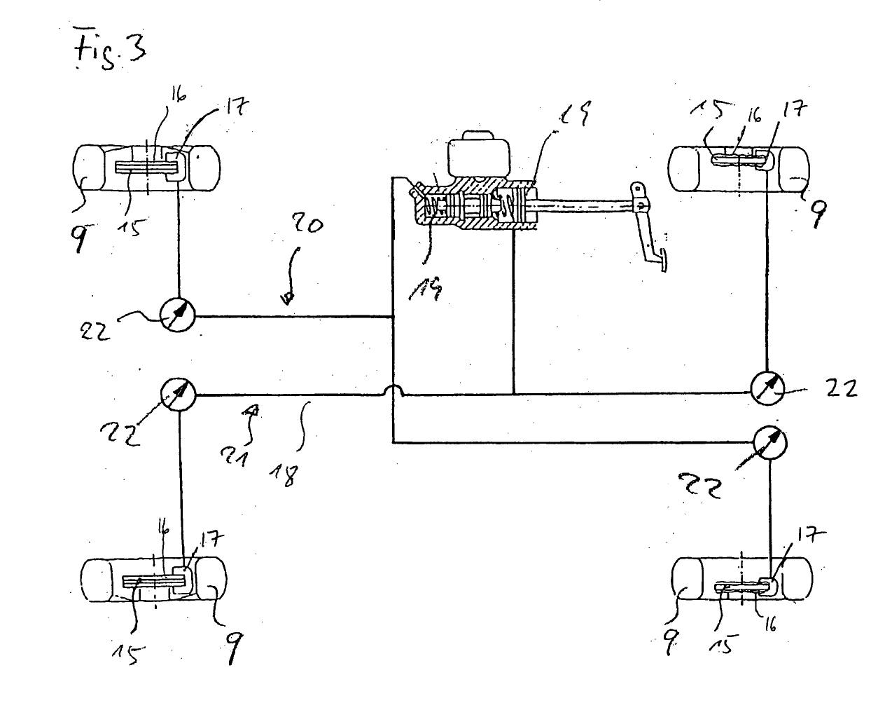

FIG. 3 shows a diagram of a hydraulic brake system of a motor vehicle. Four wheels 9 are shown, each of them having a brake disk 15 attached to it in such a way that it rotates with it. A brake caliper 16, including a hydraulically operable brake cylinder as slave cylinder 17 and pads, is in turn provided for each brake disk 15, the brake caliper 16 being essentially fixed to the vehicle body in relation to the rotation axis of wheels 9 or brake disks 15. The disk brakes composed of brake disks 15, brake caliper 16, and slave cylinders 17 are known per se. Similarly, hydraulic drum brake systems may also be used here. In place of a brake system having four disk brakes, a brake system having one, two three or any number of brakes, may be used here.

Slave cylinders 17 are connected to a master cylinder 19 via pressure medium lines 18. It is normal to split the brake systems into two independent hydraulic circuits, as is also shown in FIG. 3, namely a first brake circuit 20 and a second brake circuit 21. The brake circuits each act on diagonally opposite wheels; for example, first brake circuit 20 acts on the left front wheel and the right rear wheel and second brake circuit 21 on the right front wheel and the left rear wheel, or visa versa. An independent master cylinder is provided to operate each brake circuit 20, 21.

A pump 22 is assigned to each slave cylinder 17 in each brake circuit 20, 21. Using each of the pumps 22, the braking pressure in the corresponding slave cylinder 17 may be increased, or if necessary, also decreased. Pumps 22 are preferably electrically driven using an electric motor; other drive variants, such as hydraulic or pneumatic drives, are also conceivable.

Pumps 22 assume the functionality of an anti-lock brake system for slave cylinders 17 to which they are assigned and thus also for the corresponding wheel 9. The pressure in the slave cylinder 17 concerned is increased or decreased in such a way that overall a balanced braking effect of the vehicle is achieved, without individual wheels locking up. For this purpose, a speed sensor, or the like, whose signals may be analyzed by control electronics, is assigned to each of wheels 9, the control electronics activating the relevant pumps 22.

References

1 Drive engine

2 Clutch

3 Clutch shaft

4 Release bearing

5 Release lever

6 Slave cylinder

7 Transmission

8 Output shaft

9 Wheel

10 Primary side

11 Secondary side

12 Braking device

13 Control unit

14 Sensor

15 Brake disk

16 Brake caliper

17 Slave cylinder

18 Pressure medium line

19 Master cylinder

20 First brake circuit

21 Second brake circuit

What is claimed is:

1. A drive train comprising:
a drive engine;
a transmission;
a clutch connecting the transmission and the drive engine;
a drive shaft; and
a braking device situated in the drive train;
sensors for detecting judder of the clutch; and
a control unit connected to the braking device and to the sensors.

2. The drive train as recited in claim 1 wherein the drive train is a motor vehicle drive train.

3. The drive train as recited in claim 1 wherein the braking device is a shaft brake situated on an input or output side of the transmission.

4. The drive train as recited in claim 1 wherein the braking device is a service brake or a parking brake assigned to a wheel.

5. The drive train as recited in claim 1 wherein the braking device includes a plurality of service brakes or parking brakes, each of the plurality being assigned to a wheel.

6. The drive train as recited in claim 1 wherein the transmission is a shiftable transmission.

7. A method for reducing clutch judder in a drive train, the drive train comprising a drive engine, a transmission, a clutch connecting the drive engine and the transmission, a drive shaft, and at least one braking device, the method comprising:
operating the braking device as a function of a clutch judder occurance.

8. The method as recited in claim 7 wherein the drive train is a motor vehicle drive train.

9. The method as recited in claim 7 wherein the braking device is operated dynamically.

10. The method as recited in claim 9 wherein the dynamic operation of the braking device is controlled as to amplitude, frequency, and phase in such a way that a braking torque of the braking device counteracts the clutch judder.

11. A method for compensating for clutch judder in a drive train comprising a drive engine, a transmission, a clutch connecting the drive engine and the transmission, at one driven wheel of a motor vehicle, the wheel being connected to a motor vehicle body via a connecting element, the method comprising:
changing a gap between natural frequencies of an engine-wheel oscillating system and a wheel-body oscillating system while the vehicle is moving away.

12. The method as recited in claim 11 wherein the natural frequency of the wheel-body oscillating system is increased.

13. The method as recited in claim 11 wherein a stiffness of the connecting element is changeable in order to change the natural frequency of the wheel-body oscillating system while the clutch is being engaged.

14. The method as recited in claim 13 wherein the stiffness is changeable by an electronic controller.

15. The method as recited in claim 14 wherein the stiffness is a spring stiffness of the connecting element.

16. The method as recited in claim 13 wherein the motor vehicle includes a means for controlling the stiffness of the connecting element, the stiffness being a spring stiffness.

17. The method as recited in claim 14 wherein the electronic controller is connected to sensors for measuring clutch judder.

18. The method as recited in claim 11 wherein the connecting element includes a rheological fluid.

19. A motor vehicle comprising:
a motor vehicle body;
a drive train including a drive engine, a transmission, a clutch connecting the drive engine and the transmission, at one driven wheel of a motor vehicle, the wheel being connected to the motor vehicle body via a connecting element; and
a controller for changing a gap between natural frequencies of an engine-wheel oscillating system and a wheel-body oscillating system while the vehicle is moving away.

20. A hydraulic brake system comprising:
a master cylinder;
a slave cylinder; and
a pressure medium line connecting the master cylinder and the slave cylinder, a pressure in the slave cylinder being regulatable relative to a pressure in the master cylinder via at least one hydraulic pump situated in the pressure medium line.

21. The hydraulic brake system as recited in claim 20 wherein the hydraulic brake system is a motor vehicle hydraulic brake system.

22. The hydraulic brake system as recited in claim 20 further comprising additional slave cylinders and brakes, a hydraulic pump being assigned to each slave cylinder and brake.

23. The hydraulic brake system as recited in claim 20 further comprising a control unit and at least one sensor assigned to the control unit for measuring a state variable of a motor vehicle.

24. The hydraulic brake system as recited in claim 23 wherein the state variable is a speed of at least one of the wheels.

25. The hydraulic brake system as recited in claim 23 wherein the at least one sensor includes a plurality of sensors having signals, the sensors being connected to the control unit, the signals being converted in the control unit into control signals for influencing the pumps to prevent locking up of wheels.

26. The hydraulic brake system as recited in claim 25 further comprising brakes, wherein a pressure of at least some of the brakes, relative to a pressure of the master cylinder controlling the brakes, is changeable by the pumps assigned to the brakes.
